(19) United States
(12) Patent Application Publication
(10) Pub. No.: US 2018/0065236 A1
(43) Pub. Date: Mar. 8, 2018

(54) FASTENER HOLDER

(71) Applicant: William F. Begley, Newtown, PA (US)

(72) Inventor: William F. Begley, Newtown, PA (US)

(21) Appl. No.: 15/559,211

(22) PCT Filed: Mar. 18, 2016
(86) PCT No.: PCT/US16/23246

§ 371 Date: Sep. 18, 2017

Related U.S. Application Data
(60) Provisional application No. 62/134,771, filed on Mar. 18, 2015.

(51) Int. Cl. B25B 23/10; B25C 3/00; B25C 9/00

(52) U.S. Cl. CPC B25B 23/10; B25C 9/00; B25C 3/008

(57) ABSTRACT

A fastener holder for assisting a user to drive a nail or a screw into a substrate or work piece may include a base, a hollow stem for receiving and guiding the fastener, and a supporting member inside the stem for maintaining the fastener in the correct orientation with respect to the surface while the fastener is being driven. The supporting member may be of various configurations and structures, such as multiple grooves, multiple elastic fins or elastic clips. The supporting member may have one or more slits to allow for expansion and accommodate different sizes of fasteners. The fastener holder may have an optional adhesive pad to be used for adhering the holder to the wall in place thus freeing the user's hand from holding the fastener while driving it into the wall. The fastener holder provides a safe and versatile device for fastening jobs.

### CROSS REFERENCE TO RELATED APPLICATIONS

This application claims priority to U.S. Provisional Application No. 62/134,771, filed Mar. 18, 2015, the disclosure of which is incorporated herein in its entirety.

### FIELD OF THE INVENTION

This document relates to devices and methods for holding and positioning fasteners on a surface.

### BACKGROUND OF THE INVENTION

Historically tools such as screwdrivers, hammers and drills are generally used to drive a fastener such as a screw or nail into a surface of choice. When using a screw, the user must hold the screw between the thumb and a finger of one hand while positioning the driver or drill with the other hand. The screw is then driven into the surface while being held with the fingers until the screw is latched or seated at the surface intended, only then the user can remove the fingers from the screw or the nail to fully drive the screw or the nail into the area of choice. The thumb and finger are in effect a means to guide the screw or the nail and are at all times at risk of being injured during the process. Methodologies to mitigate finger injuries can broadly be classified into the following categories, (1) do it yourself solutions, (2) protective gloves, (3) push hammer, (4) magnetic nail holder in hammer, (5) magnetic screw holder on electric screwdriver and (6) magnetic drive guide.

Under the do it yourself solution, one may use anything that could be found in a household that would help protect hands. Protective groves are flexible gloves that provide protection around the thumb and index finger. Push hammers are devices with a hollow shaft and a small magnet extended into a handle. The nail is then placed in the shaft and the magnet connects to the head of the nail allowing the user to push against the handle and force the nail in. A magnetic nail holder in hammer is a slot in the head of the hammer that has a small magnet to hold the nail prior to striking the surface of choice. Magnetic screw holders and driver guides are essentially the similar concepts to hold the screw or nail on the drivers.

Typically, these approaches are still less than ideal. For example, when the screws are relatively shorter than an inch, not only the handling of the tools and the screw would be more challenging but also there is a higher risk of injury to the users. Further, users with history of impaired finger movement or patient suffering from arthritic joints would have much difficulty to employ such technique, thereby exposing themselves to much higher risk of injury such as striking one's thumb, not to mention ineffective positioning of the screw or nails. Accordingly, there is a need to make the installation of fasteners easier.

### SUMMARY OF THE INVENTION

The document presently describes a fastener holder, such as a screw or nail holder, for assisting a user to drive a nail or a screw into a surface of choice. The device may include (a) a base having a top and bottom side and an outer edge, (b) a hollow stem having an outside and inside wall, a first opening end and second opening end, where the first opening end is attached to and extends from the top side of the base and the second opening end is designed for receiving a fastener, and where the inside wall forms a through passage for receiving the fastener, (c) a supporting member inside the through passage of the stem and used to receive and maintain orientation of the fastener while the fastener is being driven into a surface.

In at least one embodiment, the device has an adhesive layer affixed on one side to the bottom of the base while the opposite side of the adhesive layer has adhesive properties and can be used to adhere the fastener holder in place onto a surface. Alternatively and/or additionally, the supporting member has one or more grooves, multiple fins or multiple elastic clips that are designed to receive the screw and further guide the movement of the screw through the passage. In one embodiment, the supporting member is only available in the stem.

In one embodiment, the through passage may be in any suitable shape, for example, circular or rectangular. Alternatively and/or additionally, the through passage may extend through the base. In another embodiment, the supporting member may also extend from inside the through passage to the base. The supporting member inside the through passage may also contain axial slits and further extends longitudinally to the base, providing flexibility in expanding that allows a fastener to move into the passage space or facilitate receiving of various sizes of fasteners.

In one embodiment, a method is provided for guiding a fastener including the steps of inserting a fastener into a fastener holder, placing the bottom side of the base of the fastener holder against a surface of a work piece or a substrate, driving the fastener into the substrate and removing the fastener holder from the surface. Alternatively and/or additionally, the method also includes selecting a polymer foam fastener guide having one or more openings wherein each opening is adapted for inserting the fastener. In one embodiment, the fastener can be a screw. In another embodiment, the fastener can be a nail. The work piece or substrate can be wood, sheetrock, concrete, vinyl or other materials.

In one embodiment, a method for guiding a nail may include selecting a plastic nail holder having an opening adapted for inserting a nail and a straight stem perpendicularly standing on a base structure allowing for insertion of a nail into the opening, positioning the nail holder on a desired surface of a substrate, adhering the nail holder to a surface of choice by an adhesive layer affixed to the base, seating or suspending the nail holder on the surface of choice and driving the nail into the substrate, and removing the nail holder from the surface of the substrate. In another embodiment, the fastener can also be a screw or other types of fastener.

In one embodiment, a fastener kit may include a fastener holder and one or more fasteners. Additionally, the fastener holder may include one or more adhesive layer or pad for affixing to the bottom of the base and temporarily adhering the fastener holder to the surface of the substrate to prevent the fastened holder from moving when the fastener is being driven into the substrate. In one embodiment, the fasteners in the fastener kit may include one or more screws or nails, and/or a driving rod. Alternatively and/or additionally, the fastener kit may also include a hammer and/or screwdriver.

### BRIEF DESCRIPTION OF THE DRAWINGS

FIG. 1 is a longitudinal sectional view illustrating a fastener holder in accordance with one embodiment.

FIG. 2 is a top view of a fastener holder according to one embodiment.

FIG. 3 is a longitudinal sectional view of a fastener holder device in accordance with one embodiment.

FIGS. 4 and 5 are schematic perspective views of a fastener holder according multiple embodiments.

FIGS. 6 and 7 are top views of a fastener holder illustrating cross section of the through passage of the stem according to multiple embodiments.

FIG. 8 is a perspective view of a fastener holder according to one embodiment.

FIG. 9 is a top view of the fastener holder in FIG. 8.

FIG. 10 is a longitudinal sectional view of the fastener holder in FIG. 8.

### DETAILED DESCRIPTION OF THE INVENTION

This disclosure is not limited to particular systems, methodologies or protocols described, as these may vary. The terminology used in this description is for the purpose of describing the particular versions or embodiments only, and is not intended to limit the scope.

As used in this document, any word in singular form, along with the singular forms “a,” “an” and “the,” include the plural reference unless the context clearly dictates otherwise. Unless defined otherwise, all technical and scientific terms used herein have the same meanings as commonly understood by one of ordinary skill in the art. All publications mentioned in this document are incorporated by reference. Nothing in this document is to be construed as an admission that the embodiments described in this document are not entitled to antedate such disclosure by virtue of prior invention. As used herein, the term “comprising” means “including, but not limited to.”

The term “fastener” refers to a device that attaches or joins two pieces of items together by mechanically penetrating into both pieces and stay therein. A fastener may also refer to a device that mechanically penetrates into one substrate or work piece to be stayed therein permanently or temporarily. Examples of fasteners include a screw, a nail, a device combining the functionalities of a screw and a nail, a pin, a rod, a staple, a brad, a tack or other devices. A fastener may be made of any rigid or semi-rigid materials, such as metal, plastic, polymeric resin, nylon, vinyl or wood. Whereas various embodiments in this document may show a nail or a screw as an example, the teachings thereof may also be applicable generally to other types of fasteners.

The term “nail” refers to any spike that includes a body or shank and a point on one end. It may have a broadened flat head on the other end or a head in other form, where the head is to receive a hammering action in order for the nail to be driven into a substrate. A nail may have a smooth round shank or a shank that can be twisted, threaded or ringed. Also, the cross section of a nail's shank may be of other shapes, such as round, triangular, square or rectangular. The shank may contain or be coated with a suitable lubricant, a wax or a soap to facilitate a smooth passage or penetration into a substrate. A nail may be made of metal, plastic, polymeric resin, or wood. Examples of nails may include: common nails, box nails, anchor nails, screw nails, easing nails, ringed shank nails, brads, finishing nails, tacks and upholstery nails.

The term “screw” refers a nail-shaped fastener with one or more threads or spiral grooves around the shank and a slotted or recessed head designed to be inserted into a substrate material by rotating.

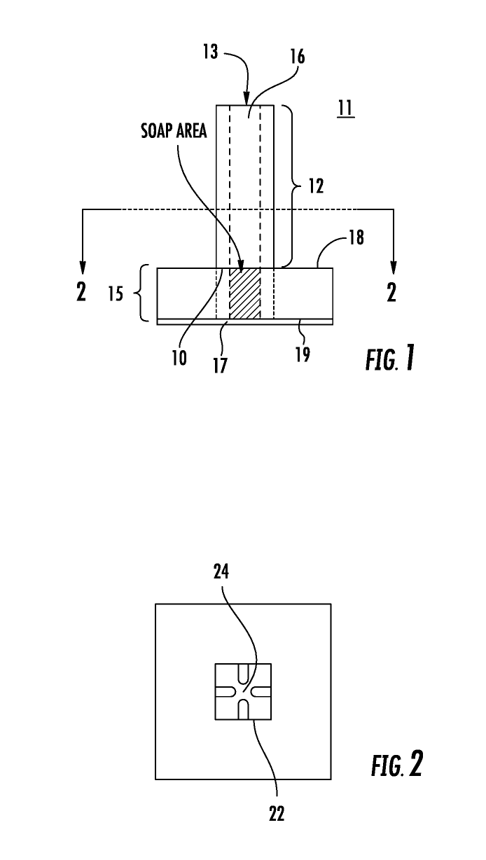

With reference to FIG. 1, according to one embodiment, a fastener holder 11 may include (a) a base 15 having a top side 18 and bottom side 19, where the base may have an opening that is sized to receive and hold a fastener such as nail or screw of various sizes, (b) a hollow stem 12 having two opening ends 10, 13, the first opening end 10 being attached to the top side of the base 18 and extending vertically from the base and the second opening end 13 being designed to receive a fastener, the hollow stem also having a through passage 16 inside the stem and configured for receiving and guiding the fastener into the base, and (c) a supporting member disposed inside the through passage 16 of the hollow stem and configured to maintain the orientation of the fastener longitudinally within the through passage.

In one embodiment, the size of the base 15 can be modified so that it fits any surface area while stabilizing the stem 12. Alternatively and/or additionally, the base 15 may be of various shapes, such as round, square, rectangular, triangle and oval, etc., to fit different applications and/or accommodate ease of manufacturing the same. Likewise, the stem 12 and the through passage 16 may be of various shapes such as round, square, rectangular, triangle and oval, etc. The length of the stem 12 may vary as well to suit different sizes of the fastener.

In one embodiment, the fastener holder may further comprise an adhesive layer 17, with one side being affixed to at least a portion of the bottom side of the base 19, and the opposite side of the adhesive layer having adhesive properties (adhesive side) for adhering the fastener holder in place to the surface of a substrate or work piece in which the fastener is to be driven. In one embodiment, the adhesive layer may be covered with a protective cover sheet to minimize undesirable stickiness while not in use. The protective cover sheet can be easily removed or peeled prior to using the fastener holder. The substrate structure in which the fastener is to be driven may be of wood, metal, natural rocks, sheetrock, cement and the like, where inserting a nail or screw is practical and desired.

Alternatively and/or additionally, the stem 12 may contain a lubricant or soap inside the through passage. For example, the lubricant or soap may be placed within the base or at least a section of the through passage inside the stem to facilitate ease of passage of the fastener through the stem and the base. Alternatively and/or additionally, the lubricant or soap may be placed on the shank section of the nails.

With reference to FIG. 2, both the stem and through passage inside the stem can be of the shape of square. The supporting member 22 can be placed inside the through passage in the stem and/or affixed to the inside wall of the stem. The supporting member is designed to keep the fastener in place while receiving and guiding the fastener longitudinally through the passage and further into the surface area of the substrate. The supporting member may be in various configurations and shapes, such as ridges, fins, clips, foams or the like. For example, the supporting member 22 may include multiple fins. The fins will leave a space in the center of the through passage 24 to allow the fastener to pass through the center of the through passage longitudinally while the fins are operatively in touch with the fastener and strong enough to hold the fastener centered. The fins may be designed to have certain flexibilities (e.g. elastic or semi-elastic) that can be adapted to various sizes of fasteners.

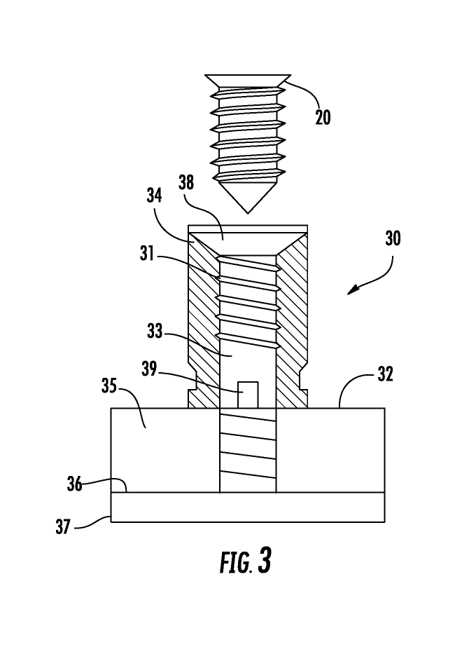

With reference to FIG. 3, according to one embodiment, a screw holder 30 may include a non-flexible rigid stem wall 34 with a through passage 33 inside the stem wall and a base 35. The steam wall 34 is attached to the base 35 and extends vertically (and preferably perpendicularly) from the base. An opening end of the stem 38 has a beveled screw insertion point designed to accommodate various sizes of screws. The diameter of the beveled insertion point is preferably larger than the head of the screws to be accommodated, allowing the screws to pass through the through passage 33 and through the base. The base 35 has top side 32 and a bottom side 36 that are preferably substantially parallel to each other, and both sides 32, 36 are preferably perpendicular to the stem wall 34. The bottom side 36 is an approximately or substantially flat surface that will come to direct contact with a substrate or work piece.

Additionally, an adhesive layer or an adhesive pad 37 can be affixed to the bottom side of the base 36. The adhesive layer or pad can be optionally covered by a protective sheet or paper/film to minimize the risk of unintended adhesion to undesirable surfaces when not in use. When in use, the protective sheet can be removed and the adhesive layer or pad can be used to adhere the screw holder in place against the substrate or work piece, in which the screw is to be driven. Once the screw is secured inside the substrate, the screw holder can be removed by the user or left in place until the screw is driven all the way into the substrate. The through passage 33 may extend through the base structure and optionally through the adhesive to facilitate proper reach to the substrate or work piece.

The screw holder may be of various sizes to accommodate various types of screws or fasteners. According to one embodiment, the distance between the top and bottom sides of the base may range from ⅛ to ½ inch, and preferably ¼ inch. The length of the stem 34, measured from the top of the stem wall to the top side of the base 32, and can range from ¼ to 2 inches, preferably between ½ to about ¾ of an inch. The opening insertion point 38 positioned on top of the stem can assume different shapes such as circle, square or triangle, so long as it allows insertion of a suitable size screw or nail through the stem and through passage inside the stem.

In one embodiment, the thickness of the base 35 can be in the range between about ⅛ inch to about 1 inch, and preferably between about ¼ inch and about ⅜ of an inch. In another embodiment, the thickness of the base 35 can range between about ¼ inch to about 1 inch, and preferably range between about ¼ and about ¾ of an inch.

With further reference to FIG. 3, according to one embodiment, in order to more precisely position a fastener, a supporting member can be placed inside the through passage 33 inside the stem wall 34, and the supporting member can have one or more ridges or grooves 31 that are sized to fit to a screw. This allows the rotation of the screw inside the through passage while being guided/driven in its desired position. Alternatively and/or additionally, a portion of the supporting member may contain an axial slit 39 to allow the supporting member or through passage to expand thus provide suitable flexibility within the through passage and the stem so that the screw can move through the entire fastener holder device 30. This will accommodate a screw or nail that has a head slightly larger than the diameter of the screw body or the nail shank. As shown in FIG. 3, the screw 20 is already in a position to be inserted, to be reaching through the opening and inserting point 38, and subsequently through the base 35, and the adhesive layer 37 into the substrate or work piece surface.

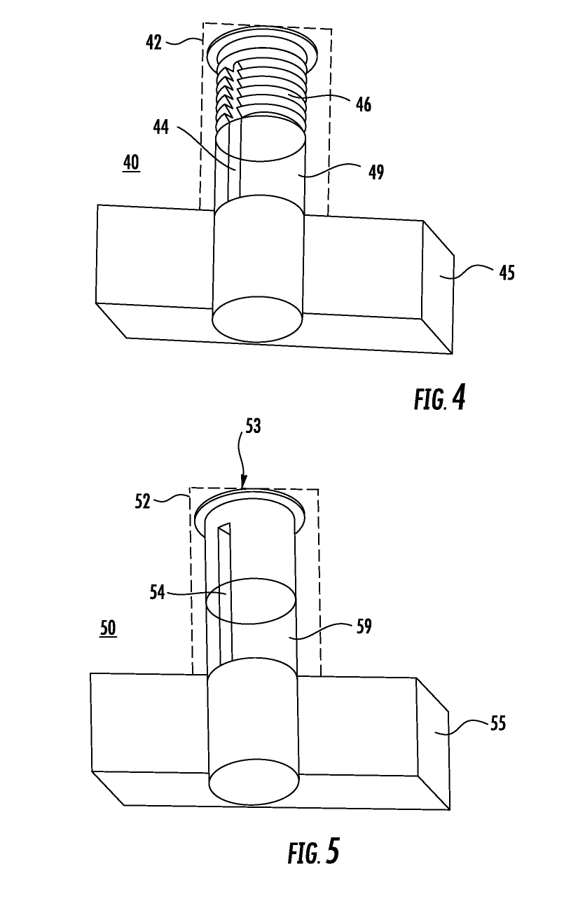

Various alternative embodiments are now further described. With reference to FIG. 4, in one embodiment, a screw holder 40 may contain a round through passage 49 inside the stem 42, and the through passage 49 may contain a supporting member that is made of a plurality of grooves or ridges 46 in a section of the stem distal from the base and designed only to receive a screw. Yet the lower section of the through passage of the stem 49 proximate to the base may contain no grooves or ridges in order to allow passage of the head of the screw through the stem, the base 45 and into the surface of substrate/work piece. Alternatively and/or additionally, one or more axial slits 44 may be further provided to allow the supporting member to expand in order to receive larger screws. In at least one embodiment, the base 45 may further contain an adhesive layer. In at least another embodiment, similar to FIG. 1, the adhesive layer can be affixed to the bottom side of the base 45 and may further be covered by a removable sheet to minimize undesirable stickiness when the screw holder is not in use.

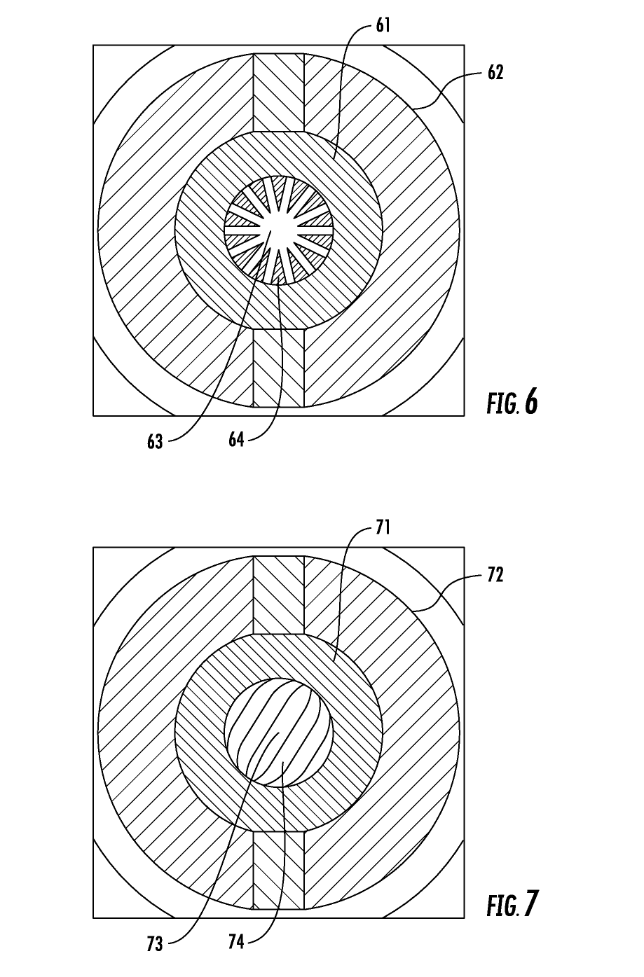

With reference to FIG. 5, in one embodiment, a nail holder 50 may contain a round through passage 59 inside the stem 52, and the through passage 59 may contain a supporting member that is made of a plurality of fins (64 in FIG. 6 or 22 in FIG. 2) that are operatively in touch with a nail and hold the nail in the center of the through passage (63 in FIG. 6) before application of any force. The supporting member may also provide an axial slit 54 to allow passage of a larger sized nail or the head of the nail through the through passage 59 to the base 55 and into the substrate/work piece. In at least one embodiment, the base structure 55 may further contain an adhesive layer. Similar to FIG. 1, the adhesive layer can be affixed to the bottom side of the base 55 and may further be covered by a removable sheet to minimize undesirable stickiness when the nail holder is not in use.

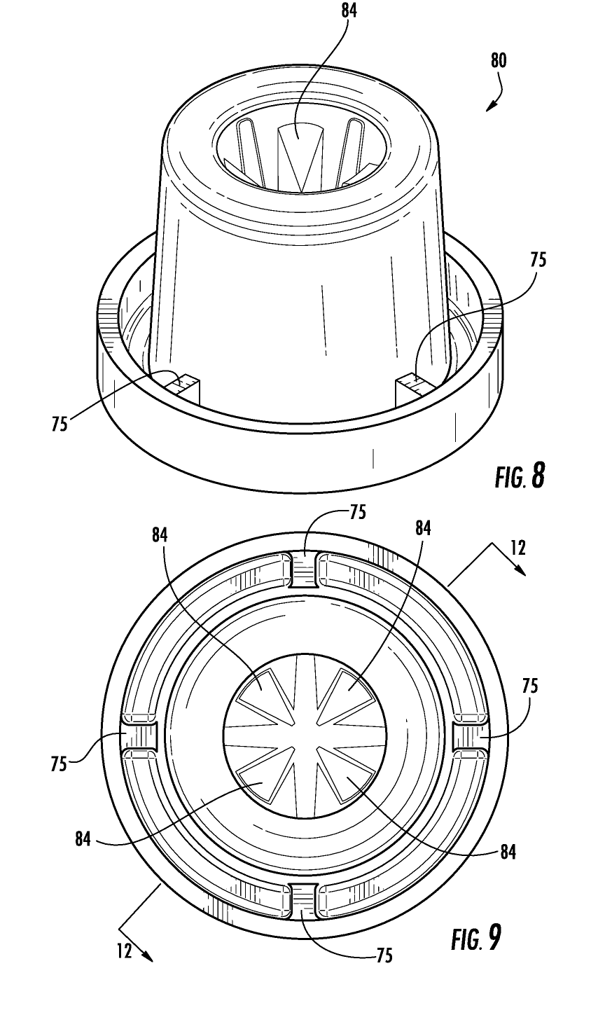

With reference to FIGS. 6 and 7, the stem may include walls made of flexible density foam, including Styrofoam, in various shapes, such as circular, triangular or rectangular. The density of the foam may change from outside to inside. As such in one embodiment, the foam may have a higher density at the outside walls 62, 72, while the density is gradually lowered in further internal sections 61, 71, and the density is the lowest at the center of the supporting member 63, 73. In one embodiment, the supporting member may be made of foams designed to receive a nail by providing multiple fins 64 to allow positioning of the nail in the center of the through passage 63. The nail can easily be pressed inside the through passage and be held firm until external force drives the nail further into the surface of choice. The fins may be made of rigid, semi-rigid or soft materials. In another embodiment, the foam may provide multiple grooves or ridges designed to receive a screw while allowing the turning of the screw for proper insertion into through passage of the stem. In another embodiment, a uniform foam structure may optionally contain a lubricant or soap 74 to act as a supporting member. For example, at least a portion or the entire the passage may comprise a lubricant or soap. A suitable lubricant may be 90% base oil or of petroleum, hydrogenated polyolefin, or silicon. Non-liquid lubricants include grease, powder, or dry graphite. Soap is particularly a good lubricant for delivery of screws through the stem or base structure.

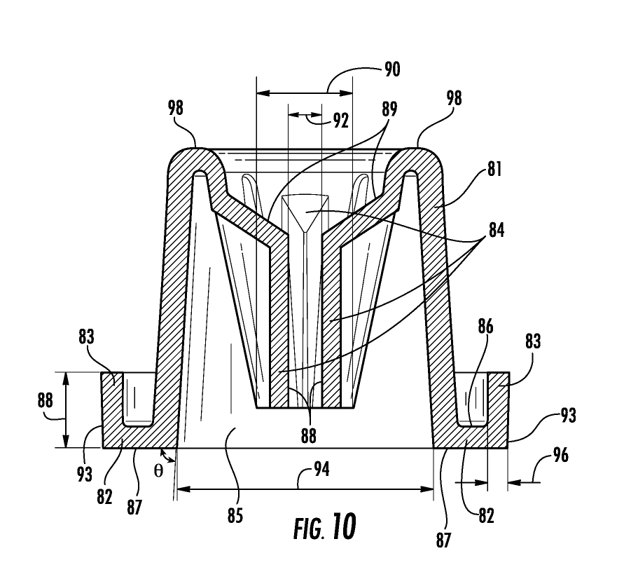

With reference to FIG. 8, a perspective of a screw or nail holder according to one embodiment is shown. The shape of the base and stem may be round. A longitudinal sectional view at line 12 is shown in FIG. 10, and the top view of the fastener holder of FIG. 8 is shown in FIG. 9. With reference to FIG. 10, a screw or nail holder may include (a) a base 82 having a top side 86 and bottom side 87, (b) a hollow stem 81 having a through passage 85, the hollow stem attaching to and extending from the top side of the base 86 vertically and slightly inward towards the center of the base, thus the stem wall 81 forming an angle θ with the bottom side of the base 87 where θ is less than 90 degrees, and (c) a supporting member inside the stem 81, containing multiple clips 84 designed to hold a screw or nail in the center of the passage 85 and allow the screw or nail to pass through the passage towards the base 82. The stem can be of different shapes such as a cylindrical shape with its axial center aligned with the center of the base. In one embodiment, the stem is attached to the base and extends vertically all the way from the bottom side of the base 87 thus the size of the opening in the base is the same as that of the through passage of the stem. Alternatively, the opening of the base may be larger or smaller than that of the through passage of the stem.

With further reference to FIG. 10, a vertical return wall 83 can be extended from an outer edge of the base 93 perpendicular to the top side of the base 86 so that the vertical return wall 83, the top side of the base 86 and the stem wall 81 form a space that allows for installment of one or more reinforcement bars 75 (FIGS. 8 and 9). This structure forms a strong base with significant saving on the material and cost. Alternatively and/or additionally, the device may have an adhesive layer affixed to the bottom side of the base 87.

The supporting member can be of various configurations. In one embodiment, the multiple clips can be made of the same material as the stem wall and formed as the stem wall is wrapped around inside at its top 98. In one embodiment, the stem can be of rigid with higher density materials while the clips (formed inside the stem) can be of lower density materials, making it possess elastic property that allows the head of a screw or nail to “squeeze” and pass through the center. In another embodiment, the clips may be made of separate pieces from the stem and attached to the inside wall of the stem. The clips can be of various designs to accommodate different types of fasteners and different sizes of fasteners. For example, each of the inner sides of the clips towards the center 88 can be flat surface allowing a nail to pass through easily. In another example, each of the inner sides of the clips 88 can have multiple grooves to accommodate the passage of a screw. In another example, inner sides of the clips 88 can have flat surface yet can be made soft enough such that when a metal screw passes through the clips, the sharp edges of the threads of the screw will operatively touch the inner sides of the clips 88 and form groves on the inner sides while the screw is turning. The new formed grooves in turn will facilitate guiding the screw through the passage of the stem and the base to the surface of the substrate.

In one embodiment, the top of the clips 89 can be lower than the top of the stem 98 to allow the fastener to further sink into the stem. The top of the clips 89 can also be of different configurations. For example, the top of the clips 89 can be angled downward from the stem wall 81 towards the center of the passage 85. When the head of a screw is at a larger diameter than that of the body of the screw, this angled top of the clip allows the head to be “squeezed” easily into the passage towards the base and to reach the surface of the substrate/work piece.

In one embodiment, the fastener holder device provides a nail or screw holder having a base for which the area of the bottom or top side ranges from ⅛ to 3 square inches, preferably in the ranges between ¼ to 1¾ square inches, and a height dimension ranging from ⅛ to 1½ inches, preferably in the ranges of ⅛ to 1 inches. In one embodiment, the fastener holder has a base with the area of ¾ square inches and a height of 1 inch. In another embodiment, the cross-section area of the through passage covers ⅓ to ⅔ of the surface area of top or bottom of the base.

In one embodiment, the fastener holder is a screw holder device having an adhesive layer affixed to the bottom side of the base. The thickness of such adhesive layer may be in the range between 1/48 to about ¼ of an inch. In a preferred embodiment, the adhesive layer has a thickness ranging from 1/32 to about ⅛ of an inch. In one embodiment, the adhesive layer is of material that provides temporary adhesion to the surface of interest, yet, is capable of being removed. In at least one embodiment, the adhesive layer provides adhesion of the fastener holder device for at least 1, 5, 8, 10 or 20 minutes or more.

Various embodiments of the fastener holder described in this document will address the problem of requiring a hand to hold a fastener while inserting or rotating the fastener to be placed in its desired position. In one embodiment, a method for driving a fastener to a substrate or work piece using the fastener holder disclosed in this document may include (a) placing a fastener into a fastener holder, (b) placing the bottom side of the base against a surface of the substrate, (c) driving the fastener at least partially into the substrate, and (d) removing the fastener holder from the surface of the substrate. In one embodiment, the substrate or work piece may be a wall or furniture or any suitable surface that requires insertion of a nail therein.

Additionally, if the fastener holder has an adhesive layer or pad affixed to the bottom of the base and with a protective cover, the method of placing the bottom side of the base against the surface of the substrate may further include peeling off the protective cover from the adhesive layer and adhering the adhesive layer or pad against the surface of the substrate. With the adhesive layer, the fastener holder can stay on the surface of the substrate or work piece temporarily, freeing a user's hand from having to hold the fastener while the user operates a screwdriver. Alternatively, with or without the adhesive layer, the user can still maintain the fastener in proper position by holding the fastener holder instead the fastener while the fastener is being driven with another hand. This provides a safer environment because the user does not need to directly hold a screw or nail with fingers but a screw or nail holder instead. In another embodiment, with a nail holder, a user can use a hammer to drive a nail into the surface of choice without a need for a hand support. In another embodiment, the holder can be removed once the nail or screw is securely fastened at the surface of choice.

In still another embodiment, a method is provided for guiding a nail wherein the method includes selecting a polymer foam nail holder having an opening adapted for inserting a nail and a straight through passage perpendicularly positioned on a base, exposing the adhesive layer side of the base by removing the protective sheet and adhering the holder on a surface of the area, wherein the holder either sits or stays suspended from the surface area of choice, inserting a nail into the insertion point opening, positioning the hammer or a driver on the head of the nail driving it at least partially into a work piece, and removing or detaching the nail holder from the work piece.

In hammering a nail into the wall with a nail holder described in this document, a nail may not be able to go into the substrate or work piece all the way in so that the head of the nail can flush with the surface of the substrate. This is because the stem has a height that prevents a user from continuing to hammer once the head of the nail reaches to the top of the stem. According to one embodiment, the nail holder may come with an extension pin or rod that user can place on the head of the nail and hammer the driving rod in order to drive the nail into the substrate.

Various embodiments in this document are provided with one or more adhesive layers on the foam bodies to provide additional benefits. Different types of adhesives can be used, but adhesives which are known as “pressure sensitive adhesives” (PSA) are preferred. PSA are adhesives which remain somewhat tacky and which provide relatively low bond strength between the adhesive and smooth rigid substrates thus resulting in an adhesive which has an easily removable, temporary bond with such substrates. The exposed PSA layer needs to be covered with a protective sheet in order to prevent unwanted adhesion when the PSA layer makes unintentional contact with a substrate. Suitable compounds for obtaining a non-adherent, release coating on sheet materials are described in U.S. Pat. No. 3,900,617 (Grenoble, 1975), and herein incorporated by reference in its entirety.

Several techniques are available for applying a PSA layer to a surface. For example, adhesive tapes, which include PSA layers bonded to both sides of a carrier may be suitable as the adhesive layer for the fastener holder. Such tapes are commercially available and these are commonly referred to as double sided adhesive tapes. The exposed surface of PSA layer is covered with release sheet.

In a more preferred embodiment the adhesives are designed to stay adhered to the work piece surface for a specific period of time. Such period of time may range from 30 seconds to 20 minutes, preferably 1, 5, 8, 10 or 15 minutes. The duration of adhesion and the strength of adhesiveness is a function of the thickness of the adhesive layer, the weight of the fastener holder and the employed polymeric material.

The embodiments of the present invention wherein one or more adhesive layers are employed are illustrated herein with adhesive layers, which cover the entire area of the bottom side of the base. However, it may be equally operable when the adhesive layer does not cover the entire area of the bottom side of the base but instead at least a portion of it.

While the invention has been illustrated with foam bodies having one or two openings, the invention is equally operable with foam bodies having multiple openings. The above embodiments of the present invention are illustrated using flexible polymer foam bodies having an approximately rectangular shape. The invention is equally operable when the foam body has a non-rectangular shape, such as, for example an oval or circular shape. The length and width of the foam bodies is not critical. A preferred length range is from about 1¼ inch to about 3½ inch. A preferred width range is from about ¾ inch to about 1¾ inch.

Various materials can be used to the making of the fastener holder. In one embodiment, a nail or the screw holder according to various embodiments is of soft, monolithic, plastic material having an outer rigid structure, while being less rigid internally. In one preferred embodiment, the holder of the present invention is of polymeric foam. In another embodiment, the density of the polymeric foam lowers from outside to inside.

The term polymer foam as defined herein includes two-phase, gas-solid systems having a solid continuous phase comprising one or more plastic or elastomer polymers. Polymer foams are generally characterized as either flexible or rigid. Polymer foams, which are suitable for the nail guides of the present invention, are flexible and require sufficient flexibility to allow bending at room temperature around without causing substantial cracking of the foam.

Polymer foams are produced in a wide range of densities. Polymer foams suitable for nail holder of the present invention have a density ranging from about 0.5 pounds per cubic foot (pcf) to about 10 pcf. A preferred density range is from about 1.0 pcf to about 7 pcf. In yet another preferred embodiment, the density range is from 1.5 pcf to 4 pcf. An example of preferred foams for use in the present invention is closed cell flexible polyethylene foam having a density of 0.5-3 pcf.

Examples of plastic and elastomer polymers suitable for use in the nail holder of the present invention include ethylene-vinylacetate copolymer, natural rubber, polychloroprene, polyethylene, polyisoprene, polyolefin, polypropylene, polyurethane, polyvinyl acetate, polyvinyl chloride and styrene-butadiene copolymer.

According to one embodiment, a fastener kit may include a fastener holder as disclosed above. The kit may also include one or more fasteners that can be accommodated by the fastener holder, such as nails and screws. The kid may also include a hammer or a driver customized for passage through the fastener holder disclosed in this document. In at least one embodiment, a hammer or other impact tool is used to strike the head of the nail until the nail is seated in the work piece such that the nail no longer needs to be held or guided. The nail holder is then removed before fully driving the nail into the work piece.

In another embodiment, the fastener kit can include a driving rod that is designed to aid the driving of a nail. It is to be placed against the head of the nail and goes through the passage of the stem. A user will hammer on the driving rod instead of the nail, to drive the nail into the substrate. The driving rod can be of any length and is preferably at a length equal or longer than the height of the stem and base together, thus preventing the hammer from hitting the stem before the head of the nail flushes with the surface of the substrate.

In one embodiment, the nail holder may be removed by pulling the adhesive layer from the surface of the substrate followed by removing the entire structure through the portion of the nail that is still outside the substrate. In another embodiment, the supporting member and stem may be disassembled allowing the nail to remain on the surface area of choice. In another embodiment, the entire fastener holder may be cracked split under a predetermined pressure, facilitating the breakage. In another embodiment, the stem can flexible and foldable to fit different nail sizes. In one embodiment, the release sheet is removed from surfaces, exposing PSA layer.

In at least another embodiment, persons who have disabilities or are limited to the use of only one hand can use the aforementioned teachings to guide and drive a nail into a work piece. The fastener holder disclosed in this document is particularly useful when the surface of the work piece is uneven or non-flat because the foam bodies are easily deformed due to the flexibility and low density of the foam bodies. The flexibility and low density also enable persons with impaired finger to use to hold the nail guide, and be able to effectively guide and drive a nail into a work piece surface. Similarly, these devices provide safety measures for children who use a hammer since the nail guides of the current invention greatly reduce the risk of hitting one's finger or thumb with the hammer.

The above-disclosed features and functions, as well as alternatives, may be combined into many other different systems or applications. Various presently unforeseen or unanticipated alternatives, modifications, variations or improvements may be made by those skilled in the art, each of which is also intended to be encompassed by the disclosed embodiments.

What is claimed is:

1. A fastener holder comprising:
a base having a top and a bottom side and an outer edge;
a hollow stem having an outside and inside wall, a first opening end extending from the top side of the base and a second opening end for receiving a fastener, wherein the inside wall defines a through passage; and
a supporting member disposed inside the through passage and configured to receive and maintain orientation of the fastener while the fastener is being driven into a substrate.

2. The fastener holder of claim 1 further comprising an adhesive layer having a first and a second side, wherein the first side has adhesive properties and the second side is affixed to at least a portion of the bottom side of the base.

3. The fastener holder of claim 1, wherein the fastener is a screw or a nail.

4. The fastener holder of claim 1, wherein the area of the bottom side of the base is in the range between 1 and 3 square inches and the base has a height of at least ⅛ of an inch.

5. The fastener holder of claim 1, wherein the through passage defines a cross-section area that is about two thirds of the area of the bottom side of the base.

6. The fastener holder of claim 2, wherein the adhesive layer has a thickness ranging from 1/32 to about ⅛ of an inch.

7. The fastener holder of claim 2, wherein the adhesive layer is made of polymeric moiety.

8. The fastener holder of claim 1, wherein the supporting member comprises a plurality of grooves configured to fit the size of the fastener.

9. The fastener holder of claim 1, wherein the supporting member comprises a plurality of fins configured to receive and hold the fastener longitudinally inside the through passage.

10. The fastener holder of claim 1, wherein the supporting member comprises a plurality of elastic clips configured to receive and hold the fastener longitudinally inside the through passage.

11. The fastener holder of claim 1, wherein the supporting member comprises one or more axial slits configured to expand to fit the fastener.

12. The fastener holder of claim 1, wherein the stem is made of a material selected from the group consisting of polymer, plastic and foam.

13. The fastener holder of claim 1 further comprising a return wall extending from the outer edge of the base perpendicular to the top side of the base so that the return wall, the top side of the base and the outside wall of the stem form a space.

14. A method of driving a fastener to a substrate, comprising:
placing a fastener into a fastener holder, wherein the fastener holder comprises:
a base having a top and a bottom side and an outer edge,
a hollow stem having an outside and inside wall, a first opening end extending from the top side of the base and a second opening end for receiving a fastener, wherein the inside wall defines a through passage, and
a supporting member disposed inside the through passage of the stem and configured to receive and maintain orientation of a fastener while the fastener is being driven into a substrate;
placing the bottom side of the base against a surface of the substrate;
driving the fastener at least partially into the substrate; and
removing the fastener holder from the surface of the substrate.

15. The method of claim 14, wherein the substrate is made of wood, concrete, sheetrock or a composite material.

16. The method of claim 14, wherein the fastener is a screw or a nail.

17. The method of claim 14, wherein driving the fastener into the substrate comprises using a screwdriver to drive the fastener into the substrate.

18. The method of claim 14, wherein driving the fastener into the substrate comprises hammering the fastener into the substrate.

19. The method of claim 14, wherein the fastener has a head and driving the fastener into the substrate comprises placing a driving rod on the head of the fastener and hammering the driving rod to drive the fastener into the substrate.

20. A fastener kit comprising:
a fastener holder comprising:
a base having a top and a bottom side and an outer edge,
a hollow stem having an outside and inside wall, a first opening end extending from the top side of the base and a second opening end for receiving a fastener, wherein the inside wall defines a through passage, and
a supporting member disposed inside the through passage of the stem and configured to receive and maintain orientation of a fastener while the fastener is being driven into a substrate; and
one or more fasteners.

21. The fastener kit of claim 20 further comprising one or more adhesive layers, each having a first and a second side, wherein the first side has adhesive properties and the second side is affixed to at least a portion of the bottom side of the base.

22. The fastener kit of claim 20, wherein the adhesive layer comprises a protective sheet disposed on the first side.

23. The fastener kit of claim 20, wherein the one or more fasteners are screws or nails.

24. The fastener kit of claim 20 further comprising a hammer and/or a screwdriver.

25. The fastener kit of claim 20 further comprising a driving rod.
